(19) United States
(12) Patent Application Publication
(10) Pub. No.: US 2004/0201126 A1
(43) Pub. Date: Oct. 14, 2004

(54) Method and device for extruding curved extrusion profiles

(76) Inventors: Nikolaus Jakoby, Ratingen (DE); Uwe Muschalik, Duisburg (DE); James R Camp, Bonn (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/488,413

(22) PCT Filed: Aug. 20, 2002
(86) PCT No.: PCT/DE02/03029

(30) Foreign Application Priority Data
Aug. 28, 2001 (DE) 101 41 328.9

(51) Int. Cl. B29C 47/12

(52) U.S. Cl. 264/177.16; 264/285; 425/391

(57) ABSTRACT

The invention relates to a method for extruding curved extrusion products (7a, 7b), whereby the extruded profile is formed in a die that is located upstream of a crosshead (4) of an extrusion installation (1) and is subsequently curved or bent by the action of external forces. The extruded strand (7a, 7b) is taken up at the press outlet by a bearing surface (10) that supports the underside of the strand. Once a partial length of strand has been separated, said length is moved (10) from the press flow and is transported away by the bearing surface, whereby the provision of a supporting surface for the subsequent strand is simultaneously maintained during said transportation by the bearing surface (10). To achieve this, a platform (10) that is located in the press outlet (5), that supports the extruded strand and that can be raised and lowered is divided into functional fields (A, B). The rear functional field (B), which adjoins the front functional field (A) closest to the machine, can be temporarily pivoted into an inclined position in relation to the base.

The invention relates to a method and a device for extruding curved extrusion profiles [structural shapes, sections], whereby the extrusion profile is formed in a female die mounted ahead of a crossbeam and is then curved or bent by the effect of external forces and then is subdivided into segments longitudinally upon further advance in the extrusion direction.

For transporting away of extruded profiles produced in an extruder or tube press or in a combined extrusion and tube press, the discharge device is set up as to be dependent upon the production program. Thus in presses for bars, structural shapes, tubes and hollow sections, the devices are equipped for straight extrusion, while for the production of wire the layout for the press requires that it be equipped with the subsequent coiler. With extrusion presses for straight extrusion, for example behind the crossbeam there can be a nondriven segment of a roller conveyor. With a coiling program, the roller conveyor segment can be shifted aside to make available place for the wire or rod feed trough. That is associated with a driven, lowerable roller conveyor with cast plates located between the driven and lowerable rollers. To avoid a sagging of the extruded product between the rollers and thus a permanent deformation, the rollers are lowered after the pressing and the pressed product or extruded profile is deposited on the plates or the support table. From this position the transport away can be effected in the usual manner.

For producing rounded extruded sections as required in various industrial fields for different purposes and which primarily are composed of aluminum and magnesium alloys, EP 0 706 843 has disclosed an extrusion press for hollow products with large wall thickness differences which has, at such a distance from the die outlet end or crossbeam, a pressing means (feed tool) which can apply a force to the extrusion that results in a reaction on the section formed in the extrusion die. With the pressing means, which can be a roller, a smooth surface, a roller cage or a like tool, a transverse force can be generated. The reshaping to a curved or bent extruded profile is effected downstream of the extrusion die in a plastic state of the workpiece.

This extruded workpiece, which is bent to one side with a predetermined radius of curvature or, alternatively, curved in both directions, is subdivided into desired segments [partial lengths]. According to an older application, this is achieved by a contactless cutting to length by burning torches which avoids any influence on the radius of curvature of the extruded profile and any fluctuations in the precision of its contour which might require an additional operating step, for example, a calibration by internal high pressure reforming to restore the extruded profile segment to the desired final contour.

It has been found that the outlet devices or roller conveyors which have become known for straight extrusion presses are not suitable for the transport of curved extruded profiles bent to one side or alternately to opposite sides and cut to length without a detrimental effect on the operation of the method or the procedure. This is a consequence on the one hand of the curvature or radius of the extruded profile and on the other hand of a continuous extrusion process since the weight of the complete charge of the mass to be extruded is naturally so selected that numerous segments can be extruded. It is a requirement that the outlet region remain free to accommodate each subsequent profile.

The invention has as its object to provide a method and device as the type set forth at the outset with which the mode of operation of the extrusion press can be improved and especially enable a problem-free unhindered extrusion pressing of a continuous sequence of extruded lengths.

This object is achieved in accordance with the method of the invention in that the extruded pressed strand at the outlet of the extruded press is received by a support [table] engaging the extrusion from the underside and after the separation of an extrusion segment from the extruded workpiece, this segment is transported from the support and moved out of the press flow and carried away. During this movement away from the support, the latter is freed up for the simultaneous receipt on the support surface of the next strand segment. With this multifunctional mode of operation of the support table in accordance with the proposal of the invention, the extrusion segments not only can be individualized but sufficient free space can be provided for the continuously following strand segment and thus for each strand segment following another there will be an equal or an equivalent or unaltered support surface available which cannot be assured for example by having the entire support surface such that it can be displaced in and out or raised and lowered.

In a preferred embodiment of the invention, the support surface can be adjustable at least as to its height. Upon a production change to an extruded profile with other dimensions, it is possible to adjust the height of the support surface that the profile outputted from the die or the cross beam with its lower edge or side emerges at the level of the upper surface of the support table. Since the extrusion press itself has a fixed center, otherwise it is possible that an extrusion profile with dimensions deviating from those of a prior extruded workpiece can emerge without being supported on the table and can kink after a certain length of extrusion at the elevated temperature thereof.

When the support surface is advantageously adjustable in a multiaxial sense, i.e. not only as to height but also in the direction of extrusion and transversely thereto it can be positioned more closely to the extruder or further therefrom depending upon the radius of curvature of the profile to be fabricated, thereby ensuring with different profiles an effective support zone which is the same or always effective.

It has been found to be advantageous to support the strand on the table with low friction which enables a clean removal of the strand from the table and a transport of the strand away from the support without damage which is particularly effective for sensitive strands, as a rule, aluminum profiles.

The device which is especially suitable for carrying out the method comprises a raisable and lowerable table which is subdivided in the pressing direction and arranged downstream of the extruder to support the extruded strand and which is subdivided into functional fields including a forward functional field close to the machine and a rear functional field downstream thereof and swingable temporarily into an inclined position relative to a foundation. The forward functional field always remains in its position and provides the main support of the profile and remains stationary also to receive the subsequently extruded profile. The rear functional field which is downwardly swingable serves to carry away the separated profile length [segment]. As soon as the desired segment length has been separated from the extrusion, for example by a cutting torch, the rear functional field is lowered so that this segment can slide from the support table downwardly. It there can be gripped, for example, by a manipulating robot and transferred to a roller conveyor which can carry it away. Until the rear functional field is swung up again into its supporting position, the subsequent extrusion profile is supported exclusively by the forward functional field.

A preferred embodiment of the invention provides that the table surface of the front functional field be fitted with rollers and the table surface of the rear functional field be formed of graphite plates. Both features contribute to the desired reduced friction which continuously enables blemish-free support and transport away of the workpiece by the support.

When, advantageously, some of the rollers of the forward function field are driven, the liberation of the press outlet region is facilitated since the driven rollers create the required gap with an already sectioned profile strand and the following profile strand more rapidly than is the case for example with free running rollers.

According to a refinement of the invention, a limited transition region adjacent the front function field, of the rear function field is equipped with rollers. In the case of a curved or bent extrusion profile segment with a large radius, these rollers support the transfer of the profiled strand to the rear function field.

For the inclination of the rear function field which is effective to slide the profile strand off the latter, an adjusting cylinder is provided which engages the rear function field laterally.

When the table, according to a further proposal of the invention, with its posts and the lifting elements, is arranged on a substructure which is displaceable longitudinally of the extrusion press direction and transversely thereto, the support table can be brought in a simple manner into the most effective position for the respective extrusion press program.

The support table is, according to the invention, provided at least at one side of an outlet roller conveyor. The one sided arrangement of the support table is sufficient when the extrusion press profile is produced with a curvature only in this direction. If, however, extrusion profiles are made with alternating direction curvatures that is with a radius of curvature to the right and to the left with respect to a straight or rectilinear extrusion path, such support tables are provided on both sides of the outlet roller conveyor.

In this case the invention proposes that both support tables are joined into a structural unit and is constituted as an integrated component or part of the outlet roller conveyor. For transfer or longitudinal displacement of the table, only a single adjusting unit is required for each direction of movement. In the formation of extrusion press profiles with a straight extrusion direction, this double table structural unit is so positioned that the roller part is flush with the usual roller conveyor rollers of the outlet roller conveyor.

Further features and details of the invention are given in the claims and in the subsequent description of the embodiment of the invention shown in the drawing. It shows:

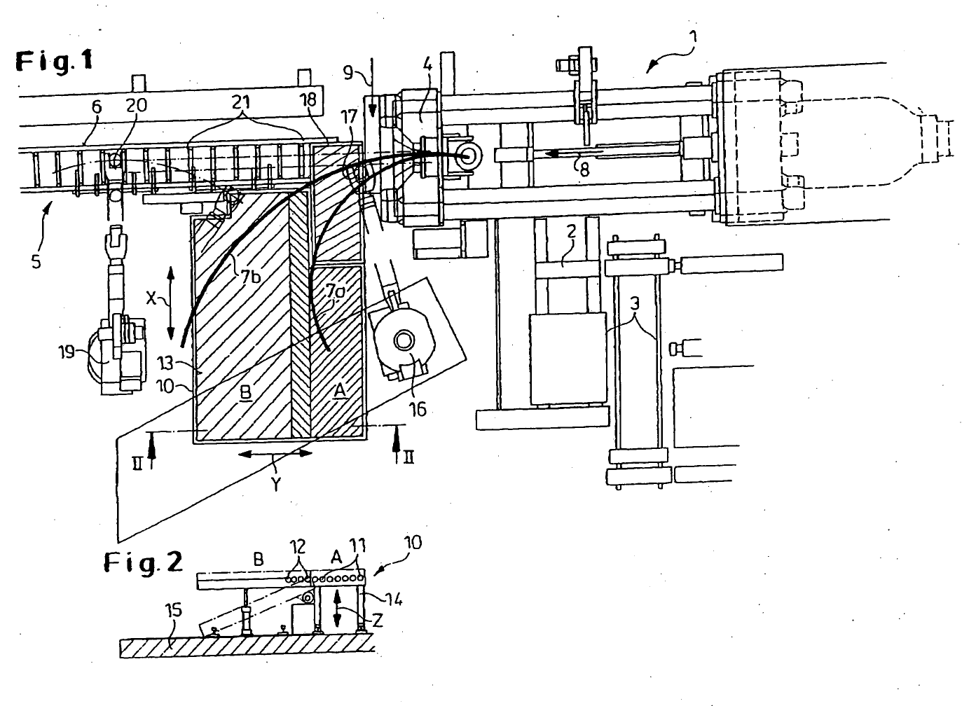

FIG. 1, is a plan view of an extrusion press and its outlet region with a support table in this embodiment on one side of the outlet roller conveyor; and

FIG. 2 the support table in section along line II-II of FIG. 1.

An extrusion press 1 as shown in FIG. 1 is supplied with a block 2 to be extruded by a loading device 3. The profile strand which is extruded through a shape-imparting die, emerges from the cross beam 4 and passes in rectilinear pressing onto an outlet roller conveyor 6 disposed at the press outlet 5.

In this embodiment, rounded strand profiles 7a, 7e are produced with a constant curvature to one side with respect to the rectilinear extrusion direction 8.

For bending the strand with the desired radius, of which in FIG. 1, stand profile 7a or 7b have been illustrated by way of example with two different radii of curvature, there is provided between the cross beam 4 and the outlet roller conveyors are guide tool schematically indicated by the arrow 9 and which imparts the curvature to the workpiece and which can operate together with a radius sensor not shown.

At the side of the roller conveyor 6 which is in the direction of curvature of the extruded profiles 7a, 7b a support surface or a support table 10 is arranged. This support table 10 is subdivided into function fields A and B, of which the function field A closest to the machine and neighboring the extrusion press is fitted with rollers 11 (compare FIG. 2) some of which are driven. The function field B is pivotally connected to the function field. This allows the function field D to be provided with a positioned cylinder which engages the functioning field B from below and laterally and to be swung thereby into the inclined position indicated by dot-dash lines. A region of the function field B adjacent the function filed A is also fitted with rollers while the much greater surface area of the function field B is covered with graphite plates 13.

The entire support table 10 whose function field A rests upon posts 14 is on the one hand adjustable with respect to its height or elevation position by means of lifting elements not shown and in the direction of the double arrow Z (FIG. 2) and on the 10 other hand is mounted on a displaceable substructure 15, for example in a cross slide arrangement in the direction of the double headed arrows X and Y, that is transversely and/or longitudinally with respect to the rectilinear extrusion pressing direction 8. The support table 10 thus permits, before extrusion press operation commences, displacement into an optimal position for the stand to be extruded, depending upon its measurements, radius of curvature and segment length.

An extrusion pressed curved or rounded stand profile 7a, 7b, emerging from the cross beam 4, is in the embodiment shown subdivided with a burner head 17 on a robot 16 by flame cutting to the desired length. The burner head follows the continuously extruded stand with the extrusion speed and separates the lengths 7a or 7b of the stand profile [segments] from the continuously pressed strand above a water trough 18 that collects the molten metal which cascades from the cut in a manner which is not detrimental to the environment. The strand profiles 7a or 7b cut to the length rest already on the rollers 11 of function field A of the support table. 10 and pass from them, especially as a result of the effect of the driven rollers from the extrusion region so that gaps are formed with the oncoming strand and the continuous extrusion of the oncoming strand is not hindered. As soon as the strand profiled 7a or 7b are completely cut to length, the function field B is swung into the inclined position toward the bottom (compare FIG. 2) so that the strand profile segments 7a or 7b slide downwardly over this surface of the function field b. A removal robot 19 can grip the strand profiles 7a or 7b from there (compare the right hand position in FIG. 1 of the gripper head 20) and transfer them to the outlet roller conveyor 6. The function field B is then swung into its horizontal position and is ready to support and transport away the next extruded profile segment.

To produce profiles with alternate curvature to both sides of the rectilinear extrusion direction 8 in a modification of the embodiment of FIG. 2 there is a support table 10 in a mirrored arrangement on the opposite side of the outlet roller conveyor 6. The support tables can be joined into a single structural unit which can be formed as an integrated component of the part 21 of the outlet roller conveyor 6.

In any case, during the entire course of production the extruded strand can be reliably supported from the bottom on support surfaces and after the separation of an extruded segment of the latter can be displaced out of the press flow and transported away so that there is no impediment or problem for the oncoming continuously extruded strand or the following strand portion cut to length. During the displacement out of the path of the oncoming strand, the preceding segment are removed without interrupting a support surface for the following strand.

1. A method of extrusion pressing curved extrusion press profiles, whereby the extrusion press profile is formed in a die of an extrusion press apparatus ahead of a cross beam and then by the effect of external force is curved or bent and in the pressing direction is subdivided into segments, characterized that in the extrusion pressed strand in the press outlet is received by a support surface supporting the strand at its underside and after the separation of a strand segment, the latter is moved out of the press flow by the support surface and transported away and whereby during the transport away the support surface is simultaneously ready to act as the support surface for the subsequent strand.

2. The method according to claim 1, characterized in that the support surface is preadjustable at least with respect to its elevation.

3. The method according to claim 1 characterized in that the strand is supported on the support surface with low friction.

4. A device for extrusion pressing curved extrusion pressed profiles whereby the extrusion press profile is formed in a die ahead of a cross beam of an extrusion press apparatus and then is curved or bent by the effect of external force and is subdivided into segments in the press flow direction, especially for carrying out the method of claim 1, characterized in that a raisable and lowerable table (10) is arranged at the press outlet (5) to support the extrusion pressed strand (7a, 7b) and is subdivided into function fields (A; B), of which the forward functional field (A) proximal to the machine has a rear functional field (B) connected thereto and temporarily swingable into a position which is inclined to the function.

5. The device according to claim 4, characterized in that the table surface of the front functional feed (A) is equipped with rollers (11) and the table surface of the rear functional field (B) is provided with graphite plates (13).

6. The device according to claim 4 characterized in that several of the rollers (11) of the forward function field (A) are driven.

7. The device according to claim 5 characterized in that a limited transfer region of the rear functional field (B) adjacent the front functional field (A) is equipped with rollers (11a).

8. The device according to claim 5 characterized by a positioning cylinder (12) which is arranged beneath the functional field B and laterally engages same.

9. The device according to claim 4 characterized in that the table (10) with its posts (14) and the displacement elements (X, Y,Z) is arranged on a substructure (15) displaceable longitudinal of transverse to the experimentation press direction (8).

10. The device according to claim 4 characterized in that the support table (10) is provided on at least one side of the outlet roller conveyor (6).

11. The device according to claim 4 characterized in that on both sides of the outlet roller conveyor (6) support tables (10) are arranged and the support tables are joined into a structural unit and are formed as an integrated part of a portion (21) of the outlet roller conveyor (6).
